(19) United States
(12) Patent Application Publication
(10) Pub. No.: US 2004/0081116 A1
(43) Pub. Date: Apr. 29, 2004

(54) Communication system with a packet-handling digital cross-connect system

(76) Inventor: John J. Clay, Olathe, KS (US)

Correspondence Address: SPRINT, 6391 SPRINT PARKWAY, KSOPHT0101-Z2100, OVERLAND PARK, KS, 66251-2100, US

(21) Appl. No.: 10/237,765

(22) Filed: Sep. 9, 2002

(51) Int. Cl. H04B 7/212

(52) U.S. Cl. 370/321

(57) ABSTRACT

A digital cross-connect system comprises a TDM system and a media gateway system. The TDM system connects access TDM connections to network TDM connections. The media gateway system is coupled some of the TDM network connections. The media gateway system receives signaling and interworks between these TDM connections and a packet connection in response to the signaling.

### RELATED APPLICATIONS

Not applicable

FEDERALLY SPONSORED RESEARCH OR DEVELOPMENT

Not applicable

### MICROFICHE APPENDIX

Not applicable

### BACKGROUND OF THE INVENTION

1. Field of the Invention

The invention is related to the field of communications, and in particular, to communication systems having digital cross-connect systems that handle packet communications.

2. Description of the Prior Art

Time Division Multiplex (TDM) connections are frequently used by telecommunication networks to transport user communications. TDM connections that link external systems to the telecommunication network are referred to as access TDM connections. TDM connections that link network elements together within the telecommunication network are referred to as network TDM connections. A Digital Cross-Connect System (DCS) inter-connects individual access TDM connections to individual network TDM connections according to a relatively static cross-connection scheme. Since the network TDM connections are also coupled to TDM switches, the DCS effectively controls the coupling of access connections to TDM switches. The coupling of access TDM connections to TDM switches is referred to as homing. The DCS is used to home call traffic from selected access connections to a new TDM switch, or to re-home traffic away from failed or old TDM switch. One example of a DCS is the Titan 5500 supplied by Tellabs.

Telecommunication networks are also deploying packet communication systems. The packet communication systems use protocols such as Asynchronous Transfer Mode (ATM), Internet Protocol (IP), and Ethernet. In packet networks, a switched virtual circuit is established for a call or session, and is torn down when the call or session ends. A permanent virtual connection is established for use on multiple calls or sessions and has a long or indefinite lifetime.

To interface between older TDM systems and newer packet systems, media gateways and soft switches have been developed. A media gateway includes User-to-Network Interface (UNI), Network-to-Network Interface (NNI), and Segmentation And Reassembly (SAR) functionality to receive control signaling, and in response to the control signaling, to interwork between a TDM connection and a packet connection. One example of control signaling is H.248. SAR functionality may include transcoding between TDM and ATM at adaption layer 2 or between TDM and IP. A soft switch receives and process call signaling to generate and transfer the gateway control signaling. The call signaling may be the same call signaling that is processed by the TDM switches, and the control signaling may indicate a TDM connection and packet header information for interworking. Thus, soft switches and media gateways can be used to replace or offload TDM switches.

The introduction of the soft switch and media gateway adds additional network elements to the telecommunication network. These network elements must be purchased, installed, and managed. Unfortunately, the purchase, installation, and management often comes at a significant cost to the telecommunication network. These additional costs may be passed on to the users of the telecommunication network.

### SUMMARY OF THE INVENTION

The invention helps solve the above problems by integrating media gateway functionality into a digital cross-connect system. The integration of the gateway functionality reduces the number of network elements. The reduction of network elements reduces network costs. Examples of the invention include digital cross-connect systems, communication systems, and their methods of operation.

Some examples of the invention include a digital cross-connect system that comprises a TDM system and a media gateway system. The digital cross-connect system connects a plurality of access TDM connections to a plurality of network TDM connections. The media gateway system is coupled to at least one of the TDM network connections. The media gateway system receives signaling and interworks between the one TDM connection and a packet connection in response to the signaling.

The following features are included in some examples of the invention. The media gateway system may provide switched virtual circuits over the packet connection in response to the signaling. The media gateway system may provide permanent virtual circuits over the packet connection in response to the signaling. The media gateway system may comprises a UNI, NNI, and SAR configured to receive the signaling and interwork in response to the signaling. One example of interworking is transcoding between TDM and ATM or IP. The media gateway system may provide echo cancellation in response to the signaling. The signaling may comprise H.248 signaling. The packet connection may comprise an ATM connection or an IP connection. The TDM connections may comprise DS1, DS3, or SONET connections.

Some examples of the invention include a communication system that comprises a soft switch and a digital cross-connect system. The soft switch receives and processes call signaling to generate and transfer gateway control signaling. The digital cross-connect system connects a plurality of access TDM connections to a plurality of network TDM connections. The digital cross-connect system receives the gateway control signaling and interworks between one of the network TDM connections and a packet connection in response to the gateway control signaling.

The following features are included in some examples of the invention. The digital cross-connect system may connect the access TDM connections to the network TDM connections on an individual connection-to-connection basis in response to connection control signaling. The digital cross-connect system may connect the access TDM connections to the network TDM connections at the individual DS0 connection level. The soft switch may receive and process the call signaling to generate and transfer the connection control signaling. The communication system may further comprise a TDM switch coupled to one of the network TDM connections. The TDM switch may receive and process other call signaling to generate and transfer the connection control signaling. The soft switch may receive and process the call signaling to generate and transfer the connection control signaling. The digital cross-connect system may provide switched virtual circuits over the packet connection in response to the gateway control signaling. The digital cross-connect system may comprise an NNI and a SAR configured to receive the gateway control signaling and interwork in response to the gateway control signaling.

Some examples of the invention include a digital cross-connect system that comprises a TDM system, an ATM gateway, and an IP gateway. The TDM system connects a plurality of access TDM connections to a plurality of network TDM connections. The ATM gateway is coupled to a first one of the TDM network connections. The ATM gateway receives ATM control signaling and interworks between the first network TDM connection and an ATM connection in response to the ATM control signaling. The IP gateway is coupled to a second one of the TDM network connections. The IP gateway receives IP control signaling and interworks between the second network TDM connection and an IP connection in response to the IP control signaling.

The following features are included in some examples of the invention. The TDM system may connect the access TDM connections to the network TDM connections on an individual connection-to-connection basis in response to connection control signaling. The TDM system may connect the access TDM connections to the network TDM connections at the individual DS0 connection level. The digital cross-connect system may further comprise echo cancellers.

### BRIEF DESCRIPTION OF THE DRAWINGS

The same reference number represents the same element on all drawings.

FIG. 1 illustrates a communication system in an example of the prior art.

FIG. 2 illustrates a communication system in an example of the invention.

FIG. 3 illustrates a communication system in an example of the invention.

### DETAILED DESCRIPTION OF THE PREFERRED EMBODIMENT

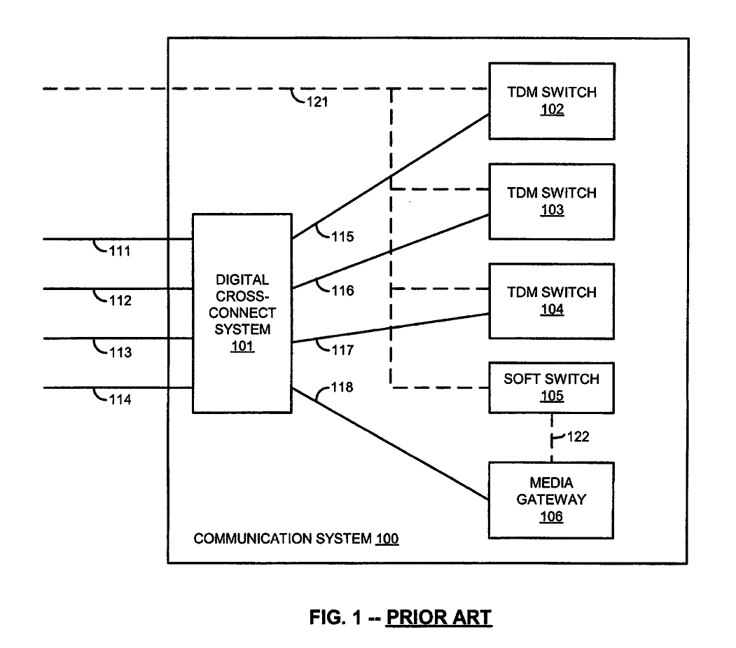

Prior Communication System Configuration and Operation—FIG. 1

A brief discussion of a prior communication system is first provided to facilitate a better understanding of the invention. FIG. 1 illustrates communication system 100 in an example of the prior art. Communication system 100 includes DCS 101, TDM switches 102-104, soft switch 105, and media gateway 106. DCS 101 is coupled to access TDM connections 111-114 where the term “access” indicates that TDM connections 111-114 are coupled to external systems that are outside of communication system 100. DCS 101 is also coupled to network TDM connections 115-118 where the term “network” indicates that TDM connections 115-118 are coupled network elements within communication system 100. TDM connections 111-118 are typically DS1, DS3, or Synchronous Optical Network (SONET) connections. TDM switches 102-104 and soft switch 105 receive call signaling 121. Soft switch 105 transfers control signaling 122 to media gateway 106.

DCS 101 connects access side TDM connections 111-114 to network TDM connections 115-118 on an individual connection-to-connection basis meaning that individual access side connections are connected to individual network side connections. The following table illustrates a sample cross-connection scheme where TDM connections in the same row are connected together.

DCS CROSS-CONNECTIONS

| ACCESS TDM | NETWORK TDM | NETWORK |
|---|---|---|
| CONNECTION | CONNECTION | ELEMENT |
| 111 | 116 | TDM SWITCH 103 |
| 112 | 118 | MEDIA GATEWAY 106 |
| 113 | 115 | TDM SWITCH 102 |
| 114 | 117 | TDM SWITCH 104 |

TDM switches 102-104 process call signaling 121 to provide telephony service to calls transported within network TDM connections 115-117. Call signaling 121 is typically Signaling System #7 (SS7) messages, T1 trunk signaling, or Integrated Services Digital Network (ISDN) signaling. Soft switch 105 also processes call signaling 121 to generate and transfer gateway control signaling 122. An example of gateway control signaling is H.248 signaling. In response to gateway control signaling 122, media gateway 106 provides telephony service to calls transported within network TDM connection 118.

On a call through TDM switch 102, the user communications will arrive in DS0 connections within TDM connections 113 and 115 based on the above cross-connect scheme. Thus, TDM connections 113 and 115 provide a relatively static DS0 call path from outside of communication system 100 through DCS 101 to TDM switch 102. TDM switch 102 receives a set-up message for the call in call signaling 121. TDM switch 102 typically processes a called number in the set-up message to extend the call from the DS0 in TDM connection 115 to another DS0 in another network connection (not shown).

On a call through media gateway 106, the user communications will arrive in DS0 connections within TDM connections 112 and 118 based on the above cross-connect scheme. Thus, TDM connections 112 and 118 provide a relatively static DS0 call path from outside of communication system 100 through DCS 101 to media gateway 106. Soft switch 105 receives a set-up message for the call in call signaling 121. Soft switch 105 typically processes a called number in the set-up message to generate and transfer gateway control signaling 122 that indicates the DS0 in TDM connection 118 and packet header information for routing. In response to gateway control signaling 122, media gateway 106 interworks the call between the DS0 connection in TDM connection 118 and packets containing the routing information in the header. Media gateway 106 typically exchanges the packets with a packet connection (not shown).

The primary function of DCS 101 is to connect individual access TDM connections 111-114 to individual network TDM connections 115-118 according to a relatively static cross-connection scheme. This functionality allows communication system 100 to transfer access TDM connections from one network element to another. For example, if TDM switch 102 were to fail, DCS 101 could disconnect access TDM connection 113 from network TDM connection 115, and re-connect access TDM connection 113 to TDM connection 118 to media gateway 106. This could be referred to as re-homing traffic from TDM switch 102 to media gateway 106.

Note that both an access and a network TDM connection could carry packets within their TDM format. Thus, DCS 101 could connect an access TDM connection to a network TDM connection to exchange packets between an external system and a network packet system having a TDM interface. Unlike media gateway 106, DCS 101 cannot dynamically interwork between TDM and packet formats in response to signaling.

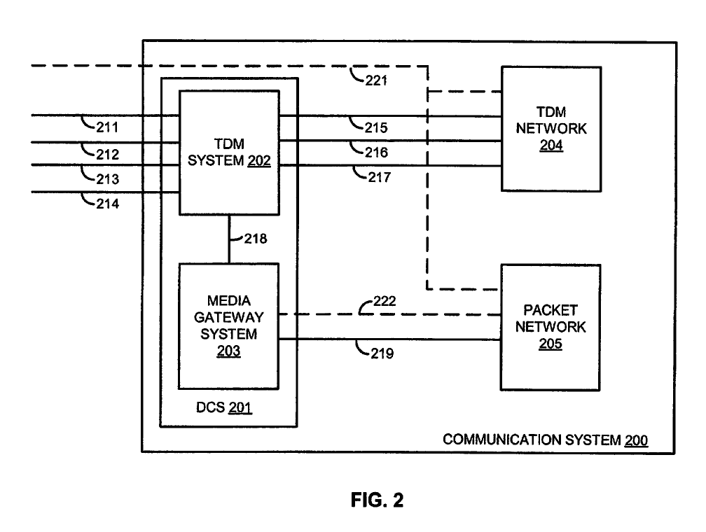

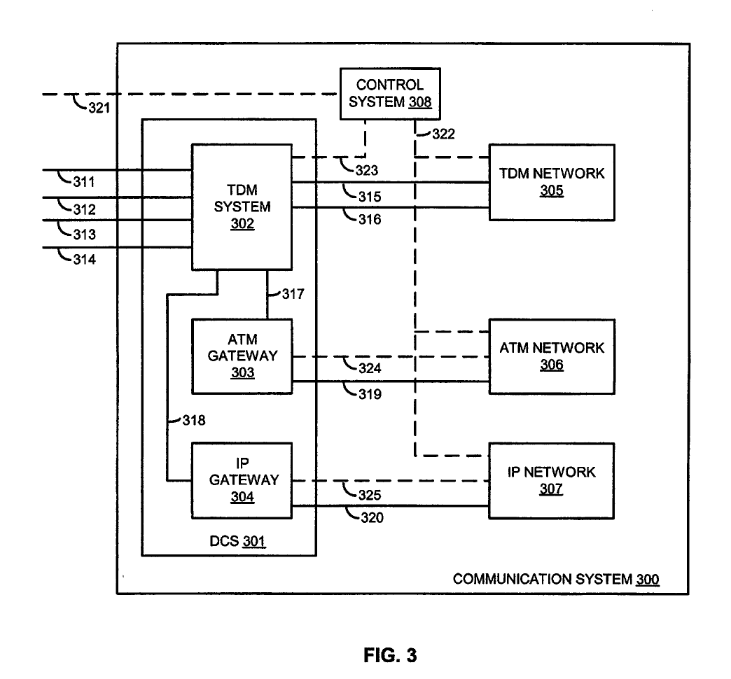

New Communication System Configuration and Operation—FIGS. 2-3

FIGS. 2-3 and the following description depict specific examples to teach those skilled in the art how to make and use the best mode of the invention. For the purpose of teaching inventive principles, some conventional aspects have been simplified or omitted.

Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 2 illustrates communication system 200 in an example of the invention. Communication system 200 includes DCS 201, TDM network 204, and packet network 205. DCS 201 includes TDM system 202 and media gateway system 203. DCS 201 is coupled to access TDM connections 211-214 and to network TDM connections 215-218.

TDM system 202 is coupled to media gateway system 203 by TDM connection 218, and media gateway system 203 is coupled to packet connection 219. TDM connections 211-218 could be DS1 connections, DS3 connections, SONET connections, or some other type of TDM communication links. Note that network TDM connection 218 that couples TDM system 202 to media gateway system 203 does not have to be a traditional connection in that it resides entirely within DCS 201 and may be an extension of one of the access TDM connections. Packet connection 219 could be an ATM connection, IP connection, Ethernet connection, or some other type of packet communication link.

Networks 204 and 205 receive call signaling 221. Call signaling 221 could be SS7 messages, T1 trunk signaling, ISDN signaling, or some other type of telecommunications signaling. Packet network 205 transfers gateway control signaling 222 to media gateway system 203. Gateway control signaling 222 could be H.248 signaling or some other type of gateway control messages.

DCS 201 connects access side TDM connections 211-214 to network TDM connections 215-218 on an individual connection-to-connection basis. TDM network 204 processes call signaling 221 to provide telephony service to calls transported within network TDM connections 215-217. Packet network 205 also processes call signaling 121 to generate and transfer gateway control signaling 222. In response to gateway control signaling 222, media gateway system 203 interworks calls between network TDM connection 218 and packet connection 219. In some examples, media gateway system 203 interworks by converting between a DS0 connection and packets with specific routing information in the header.

In the following examples, consider that DCS 201 connects access TDM connection 212 to network TDM connection 218 and connects access TDM connection 213 to network TDM connection 215. On a sample call through TDM network 204, user communications arrive on DS0 connections within TDM connections 213 and 215 based on the above cross-connect scheme. Thus, TDM connections 213 and 215 provide a DS0 call path from outside of communication system 200 through DCS 201 to TDM network 204. TDM network 204 receives a set-up message for the call in call signaling 221. TDM network 204 typically processes a called number in the set-up message to extend the call from the DS0 in TDM connection 215 to another DS0 in another network connection (not shown). In some examples, TDM network 204 includes a TDM switch to receive and process call signaling 221 to provide telephony service to the call communications on TDM connection 215.

On a sample call through media gateway system 203, the user communications will arrive on DS0 connections within TDM connections 212 and 218 based on the above cross-connect scheme. Thus, TDM connections 212 and 218 provide a DS0 call path from outside of communication system 200 through DCS 201 to media gateway system 203. Packet network 205 receives a set-up message for the call in call signaling 221. Packet network 205 typically processes a called number in the set-up message to generate and transfer gateway control signaling 222 that indicates the DS0 in TDM connection 218 and packet routing information. The routing information could be ATM virtual identifiers, IP addresses, Ethernet addresses, or some other type of packet routing data. In response to gateway control signaling 222, media gateway system 203 interworks the call between the DS0 connection in TDM connection 218 and packets containing the routing information. Media gateway system 203 exchanges the packets with packet network 205 over packet connection 219.

In some examples, packet network 205 includes a soft switch to receive and process call signaling 221 to generate and transfer gateway control signaling 222. In some examples, media gateway system 203 interworks to provide switched virtual circuits or permanent virtual circuits over packet connection 219. In some examples, media gateway system 203 includes a UNI, NNI, and SAR to receive the signaling and interwork in response to the signaling. Interworking could include transcoding between TDM and ATM at adaption layer 2 or transcoding between TDM and IP. In some examples, control signaling 222 includes echo cancellation instructions, and media gateway system 203 provides echo cancellation in response to control signaling 222.

Advantageously, the stand-alone media gateway of prior systems is not needed by communication system 200 because the media gateway functionality has been integrated within DCS 201. This integration reduces the number of network elements to purchase, install, and manage. This reduction results in significant cost savings.

FIG. 3 illustrates communication system 300 in an example of the invention. Communication system 300 includes DCS 301, TDM network 305, ATM network 306, IP network 307, and control system 308. DCS 301 includes TDM system 302, ATM gateway 303, and IP gateway 304. TDM system 302 is coupled to access TDM connections 311-314 and network TDM connections 315-318. TDM network 305 is coupled to network TDM connections 315 and 316. ATM gateway 303 is coupled to network TDM connection 317 and to ATM connection 319. IP gateway 304 is coupled to network TDM connection 318 and to IP connection 320.

Control system 308 could be comprised of conventional computer and communications circuitry and software that are configured in accord with this disclosure. Control system 308 receives call signaling 321 and transfers call signaling 322 to networks 305-307. Call signaling 321 and 322 may be the same or similar. Control system 308 transfers control signaling 323 to TDM system 302. ATM network 306 transfers control signaling 324 to ATM gateway 303. IP network 307 transfers control signaling 325 to IP gateway 304.

On a first call, control system 308 receives and processes call signaling 321 to select one of networks 305-307 to handle the first call. If TDM network 305 is selected, then control system 308 transfers corresponding call signaling 322 to TDM network 305 and transfers control signaling 323 to TDM system 302. In response to control signaling 323, TDM system 302 connects the access TDM connection for the call (one of 311-314) to a network TDM connection to TDM network 305 (one of 315-316). In some examples, this cross-connection occurs at the DS0 level between a DS0 in the access TDM connection and a DS0 in the network TDM connection. TDM network 305 processes call signaling 322 to handle the call communications on the network TDM connection.

On a second call, control system 308 receives and processes call signaling 321 to select one of networks 305-307 to handle the second call. If ATM network 305 is selected, then control system 308 transfers corresponding call signaling 322 to ATM network 306 and transfers control signaling 323 to TDM system 302. In response to control signaling 323, TDM system 302 connects the access TDM connection for the call (one of 311-314) to network TDM connection 317 to ATM gateway 303. In some examples, this cross-connection occurs at the DS0 level between a DS0 in the access TDM connection and a DS0 in the network TDM connection 317. ATM network 306 processes call signaling 322 to generate and transfer gateway control signaling 324 to ATM gateway 303. In response to the gateway control signaling 324, ATM gateway interworks the call communications between network TDM connection 317 and ATM connection 319. In some examples, the interworking occurs between a DS0 in network TDM connection 317 and an ATM Virtual Path Identifier/Virtual Connection Identifier (VPI/VCI). ATM network 306 handles the call from ATM connection 319.

On a third call, control system 308 receives and processes call signaling 321 to select one of networks 305-307 to handle the third call. If IP network 307 is selected, then control system 308 transfers corresponding call signaling 322 to IP network 307 and transfers control signaling 323 to TDM system 302. In response to control signaling 323, TDM system 302 connects the access TDM connection for the call (one of 311-314) to network TDM connection 318 to IP gateway 304. In some examples, this cross-connection occurs at the DS0 level between a DS0 in the access TDM connection and a DS0 in network TDM connection 318. IP network 307 processes call signaling 322 to generate and transfer gateway control signaling 325 to IP gateway 304. In response to the gateway control signaling 325, IP gateway 304 interworks the call communications between network TDM connection 318 and IP connection 320. In some examples, the interworking occurs between a DS0 in network TDM connection 318 and an IP address. IP network 307 handles the call from IP connection 320.

Some variations to communication system 300 are discussed below. Control system 308 could be omitted, and TDM system 302 would revert to using a relatively static cross-connection scheme. Control system 308 could be integrated within one of networks 305-307 or could be distributed among networks 305-307. Control system 308 could be integrated within a soft switch, TDM switch, STP, or DCS. Portions of signaling 321-322 could be directed to the appropriate ones of networks 305-307 without passing through control system 308. Based on this disclosure, those skilled in the art will also appreciate how to modify existing telecommunication equipment to make and use communication systems 200 and 300.

1. A digital cross-connect system comprising:
a Time Division Multiplex (TDM) system configured to connect a plurality of access TDM connections to a plurality of network TDM connections; and
a media gateway system coupled to at least one of the TDM network connections and configured to receive signaling and interwork between the one TDM connection and a packet connection in response to the signaling.

2. The digital cross-connect system of claim 1 wherein the media gateway system is configured to provide switched virtual circuits over the packet connection in response to the signaling.

3. The digital cross-connect system of claim 1 wherein the media gateway system is configured to provide permanent virtual circuits over the packet connection in response to the signaling.

4. The digital cross-connect system of claim 1 wherein the media gateway system comprises a Network-to-Network Interface (NNI) and a Segmentation And Reassembly (SAR) configured to receive the signaling and interwork in response to the signaling.

5. The digital cross-connect system of claim 1 wherein the signaling comprises H.248 signaling.

6. The digital cross-connect system of claim 1 wherein the packet connection comprises one of an Asynchronous Transfer Mode (ATM) connection and an Internet Protocol (IP) connection.

7. The digital cross-connect system of claim 1 wherein the TDM connections comprise at least one of DS1 connections, DS3 connections, and Synchronous Optical Network (SONET) connections.

8. The digital cross-connect system of claim 1 wherein the media gateway system is configured to provide echo cancellation in response to the signaling.

9. A communication system comprising:
a soft switch configured to receive and process call signaling to generate and transfer gateway control signaling; and
a digital cross-connect system configured to connect a plurality of access Time Division Multiplex (TDM) connections to a plurality of network TDM connections, receive the gateway control signaling, and interwork between one of the network TDM connections and a packet connection in response to the gateway control signaling.

10. The communication system of claim 9 wherein the digital cross-connect system is configured to connect the access TDM connections to the network TDM connections on an individual connection-to-connection basis in response to connection control signaling.

11. The communication system of claim 10 wherein the digital cross-connect system is configured to connect the access TDM connections to the network TDM connections at the individual DS0 connection level.

12. The communication system of claim 10 wherein the soft switch is configured to receive and process the call signaling to generate and transfer the connection control signaling.

13. The communication system of claim 10 further comprising a TDM switch coupled to one of the network TDM connections.

14. The communication system of claim 13 wherein the TDM switch is configured to receive and process other call signaling to generate and transfer the connection control signaling.

15. The communication system of claim 9 wherein the digital cross-connect system is configured to provide switched virtual circuits over the packet connection in response to the gateway control signaling.

16. The digital cross-connect of claim 9 wherein the digital cross-connect system comprises a Network-to-Network Interface (NNI) and a Segmentation And Reassembly (SAR) configured to receive the gateway control signaling and interwork in response to the gateway control signaling.

17. A digital cross-connect system comprising:
a Time Division Multiplex (TDM) system configured to connect a plurality of access TDM connections to a plurality of network TDM connections; and
an Asynchronous Transfer Mode (ATM) gateway coupled to a first one of the TDM network connections and configured to receive ATM control signaling and interwork between the first network TDM connection and an ATM connection in response to the ATM control signaling; and
an Internet Protocol (IP) gateway coupled to a second one of the TDM network connections and configured to receive IP control signaling and interwork between the second network TDM connection and an IP connection in response to the IP control signaling.

18. The digital cross-connect system of claim 17 wherein the TDM system is configured to connect the access TDM connections to the network TDM connections on an individual connection-to-connection basis in response to connection control signaling.

19. The digital cross-connect system of claim 17 wherein the TDM system is configured to connect the access TDM connections to the network TDM connections at the individual DS0 connection level.

20. The digital cross-connect system of claim 17 further comprising echo cancellers.

21. A method of operating a digital cross-connect system that is comprised of a Time Division Multiplex (TDM) system and a media gateway system, the method comprising:
in the TDM system, connecting a plurality of access TDM connections to a plurality of network TDM connections; and
in the media gateway system coupled to at least one of the TDM network connections, receiving signaling and interworking between the one TDM connection and a packet connection in response to the signaling.

22. The method of claim 21, wherein in the media gateway system, receiving the signaling and interworking comprises providing switched virtual circuits over the packet connection in response to the signaling.

23. The method of claim 21, wherein in the media gateway system, receiving the signaling and interworking comprises providing permanent virtual circuits over the packet connection in response to the signaling.

24. The method of claim 21 wherein the media gateway system comprises a Network-to-Network Interface (NNI) and a Segmentation And Reassembly (SAR) configured to receive the signaling and interwork in response to the signaling.

25. The method of claim 21 wherein the signaling comprises H.248 signaling.

26. The method of claim 21 wherein the packet connection comprises one of an Asynchronous Transfer Mode (ATM) connection and an Internet Protocol (IP) connection.

27. The method of claim 21 wherein the TDM connections comprise at least one of DS1 connections, DS3 connections, and Synchronous Optical Network (SONET) connections.

28. The method of claim 21 further comprising, in the media gateway system, providing echo cancellation in response to the signaling.

29. A method of operating a communication system that comprises a soft switch and a digital cross-connect system, the method comprising:
in the soft switch, receiving and processing call signaling to generate and transfer gateway control signaling; and
in the digital cross-connect system, connecting a plurality of access Time Division Multiplex (TDM) connections to a plurality of network TDM connections, receiving the gateway control signaling, and interworking between one of the network TDM connections and a packet connection in response to the gateway control signaling.

30. The method of claim 29, wherein in the digital cross-connect system, connecting the TDM connections comprises connecting the access TDM connections to the network TDM connections on an individual connection-to-connection basis in response to connection control signaling.

31. The method of claim 30, wherein in the digital cross-connect system, connecting the TDM connections comprises connecting the access TDM connections to the network TDM connections at the individual DS0 connection level.

32. The method of claim 30 further comprising, in the soft switch, receiving and processing the call signaling to generate and transfer the connection control signaling.

33. The method of claim 30 wherein the communication system further comprises a TDM switch coupled to one of the network TDM connections.

34. The method of claim 33 further comprising, in the TDM switch, receiving and processing other call signaling to generate and transfer the connection control signaling.

35. The method of claim 29, wherein in the digital cross-connect system, receiving the gateway control signaling and interworking in response to the gateway control signaling comprises providing switched virtual circuits over the packet connection in response to the gateway control signaling.

36. The method of claim 29 wherein the digital cross-connect system comprises a Network-to-Network Interface (NNI) and a Segmentation And Reassembly (SAR) configured to receive the gateway control signaling and interwork in response to the gateway control signaling.

37. A method of operating a digital cross-connect system that comprises a Time Division Multiplex (TDM) system, an Asynchronous Transfer Mode (ATM) gateway, and an Internet Protocol (IP) gateway, the method comprising:
in the TDM system, connecting a plurality of access TDM connections to a plurality of network TDM connections; and
in the ATM gateway coupled to a first one of the TDM network connections, receiving ATM control signaling and interworking between the first network TDM connection and an ATM connection in response to the ATM control signaling; and
in the IP gateway coupled to a second one of the TDM network connections, receiving IP control signaling and interworking between the second network TDM connection and an IP connection in response to the IP control signaling.

38. The method of claim 37 wherein the TDM system is configured to connect the access TDM connections to the network TDM connections on an individual connection-to-connection basis in response to connection control signaling.

39. The method of claim 37, wherein in the TDM system, connecting the TDM connections comprises connecting the access TDM connections to the network TDM connections at the individual DS0 connection level.

40. The method of claim 37 further comprising canceling echo in the digital cross-connect system.
